(19) United States
(12) Patent Application Publication
(10) Pub. No.: US 2016/0300308 A1
(43) Pub. Date: Oct. 13, 2016

(54) SYSTEMS AND METHODS FOR RETIREMENT PLANNING

(71) Applicant: FINMASON, INC., Scituate, MA (US)

(72) Inventors: Lawrence Kendrick Wakeman, Scituate, MA (US); Adam Tashman, Sudbury, MA (US); Fuqin Yan, Brighton, MA (US)

(21) Appl. No.: 15/075,613

(22) Filed: Mar. 21, 2016

Related U.S. Application Data
(60) Provisional application No. 62/145,189, filed on Apr. 9, 2015.

(51) Int. Cl. G06Q 40/06

(52) U.S. Cl. CPC G06Q 40/06

(57) ABSTRACT

Systems and methods are provided for predicting a value of an investment portfolio at retirement using one or more computer servers and storage devices. In general, the systems and methods can include a Monte Carlo simulation module that runs Monte Carlo simulations on a plurality of exemplary portfolios under a variety of exemplary circumstances to produce a range of estimated values of each exemplary portfolio at retirement. A regression analysis module can then relate the properties of the exemplary portfolios, as well as the exemplary circumstances, to the estimated values at retirement. Using the resulting regression models, a performance analysis module can predict a value of any portfolio at retirement under any set of circumstances based on properties of the portfolio. The systems and methods herein can thus calculate estimates of the value of any portfolio nearly instantaneously, without having to run a Monte Carlo simulation.

### CROSS-REFERENCE TO RELATED APPLICATIONS

This application claims priority to U.S. Provisional Application No. 62/145,189 filed on Apr. 9, 2015, which is hereby incorporated herein by reference in its entirety.

### FIELD

Exemplary embodiments of the present invention relate to systems and methods for retirement planning, and in particular to predicting a value of an investment portfolio at retirement.

### BACKGROUND

Several approaches exist for making financial investment opportunities more accessible to the individual investor. Mobile phone apps and user-friendly websites are cropping up to allow individual users to pick and choose from a variety of financial assets. While these advances have helped to provide more investment options, however, they have failed to provide meaningful analytical measures of investments to help investors choose which options are really best for them.

For example, to help investors determine what retirement strategy is best for them, some analytical platforms provide measures of the amount of savings available at retirement based on what types of assets are in their current portfolio. However, this calculation can be complicated by several variables, such as assets with high volatility, changes in investor contribution amounts, etc. Several currently available platforms run Monte Carlo simulations based on probabilistic assumptions about these variables to determine a range of possible performance outcomes. While flexible, this approach is computationally intensive. Each simulation can require more computational power than what is available on many mobile devices and can take several minutes to run—enough time for many users to lose interest.

Furthermore, many currently available analytical platforms for retirement planning require estimates for portfolio expected return and volatility to run the Monte Carlo analysis. Thus, such platforms often only provide performance metrics for a generic portfolio with given amounts of each broad asset category, e.g., stocks, bonds, etc., rather than for a particular asset or portfolio of assets.

Accordingly, there remains a need for customizable, efficient ways to estimate a value of a portfolio at retirement.

### SUMMARY

The present invention generally provides systems and methods for predicting a value of a portfolio at retirement. In one aspect, a method is provided for predicting a value of one or more portfolios of financial assets at retirement using a system comprising one or more computer processors connected to one or more computer databases. The method can include accessing from the one or more databases, by the one or more computer processors, regression parameters that approximate a Monte Carlo simulation and that correlate a set of input variables with an estimated value of a portfolio at retirement. The one or more computer processors can further access values for the set of input variables that correspond to a user portfolio and a retirement strategy and can calculate an estimated value of the user portfolio at retirement using the regression parameters, without running a Monte Carlo simulation. The estimated value can be at least one of an upper limit, a lower limit, and an average.

In some embodiments, the input variables can include at least one of an amount of time until retirement, an amount of money contributed to the user portfolio on a regular basis, an inflation rate, a volatility of the user portfolio, and an expected return of the user portfolio. Where the input variables include the expected return of the user portfolio and the volatility of the user portfolio, the one or more computer processors can calculate the expected return and the volatility of the user portfolio.

In some embodiments, the one or more computer processors can provide a user interface that allows a user to specify a second set of values for the input variables, where at least one of the values for the input variables in the first set is different from a value of that input variable in the second set. In such embodiments, the method can further include accessing the one or more databases by the one or more computer processors to retrieve the regression parameters and calculating a value of the user portfolio at retirement using the regression parameters based on the second set of values. The one or more computer processors can output to the user interface the values of the user portfolio at retirement based on the first set of values and the second set of values.

In some embodiments, the method can further include retrieving by the one or more computer processors a second set of values for the input variables that correspond to a second portfolio. The one or more computer processors can access the one or more databases to retrieve the regression parameters and can calculate a value of the second portfolio at retirement using the regression parameters. The one or more computer processors can further output to a computer display the values of the first portfolio and the second portfolio at retirement. The retrieving of a second set of values for the input variables that corresponds to the second portfolio can include providing by the one or more computer processors a user interface for a user to indicate allocations of a limited subset of financial assets in which the user is allowed to invest for retirement, and creating from indicated allocations the second portfolio. In some embodiments, the second portfolio can include at least one sponsored financial asset.

In another aspect, a method is provided for predicting a value of one or more portfolios of financial assets at retirement using a system comprising one or more computer processors connected to one or more computer databases. The method can include running, by the one or more computer processors, a Monte Carlo simulation to determine a value of each of a plurality of portfolios at retirement. The one or more computer processors can perform a regression analysis for each of the values with respect to a plurality of variables relating to each of the portfolios and can store the regression parameters in the one or more databases. The one or more computer processors can access the one or more databases to retrieve the regression parameters, can retrieve a set of values for the input variables that corresponds to a user portfolio, and can calculate a value of the user portfolio at retirement using the regression parameters.

The present invention further provides devices, systems, and methods as claimed.

### BRIEF DESCRIPTION OF THE DRAWINGS

FIG. 1 is a schematic diagram of one exemplary embodiment of a computer system;

FIG. 2 is a schematic diagram of one exemplary embodiment of a system for predicting a value of a portfolio at retirement;

FIG. 3 is a flowchart that schematically depicts an exemplary method of a Monte Carlo simulation module for use with the system of FIG. 2;

FIG. 4 is a flowchart that schematically depicts an exemplary method of a regression analysis module for use with the system of FIG. 2;

FIG. 5 is a flowchart that schematically depicts an exemplary method of a performance analysis module for use with the system of FIG. 2;

FIG. 6 is an exemplary user interface for use with the systems and methods of the invention;

FIG. 7 is another view of the exemplary user interface of FIG. 6;

FIG. 8 is another view of the exemplary user interface of FIG. 6; and

FIG. 9 is another view of the exemplary user interface of FIG. 6.

### DETAILED DESCRIPTION OF THE INVENTION

Systems and methods are provided for predicting a value of an investment portfolio at retirement using one or more computer servers and storage devices. In general, the systems and methods can include a Monte Carlo simulation module that runs Monte Carlo simulations on a plurality of exemplary portfolios under exemplary circumstances to produce a range of estimated values of each exemplary portfolio at retirement. A regression analysis module can then relate the properties of the exemplary portfolios, as well as the exemplary circumstances, to the estimated values at retirement. Using the resulting regression models, a performance analysis module can predict a value of any portfolio at retirement under a variety of circumstances. In some embodiments, properties of the portfolio that are used to predict portfolio value can also be calculated by the performance analysis module based on an identity of the assets that make up the portfolio. The performance analysis module can thus calculate estimates of the value of a specific portfolio nearly instantaneously, with minimal computational power and without having to run a Monte Carlo simulation. Due to the low computational power requirements, the performance analysis module can be run on a variety of platforms, including applications for mobile devices. The performance analysis module can be run multiple times for different portfolios and/or under different circumstances to allow users to compare savings at retirement using different investment strategies. Accordingly, using the systems and methods provided herein, a user can instantly view the impact of changing one or more parameters of their retirement strategy on the ultimate value of their portfolio at retirement, thus “gamefying” the retirement planning process.

Certain exemplary embodiments will now be described to provide an overall understanding of the principles of the structure, function, manufacture, and use of the methods, systems, and devices disclosed herein. One or more examples of these embodiments are illustrated in the accompanying drawings. Those skilled in the art will understand that the methods, systems, and devices specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Computer Processor

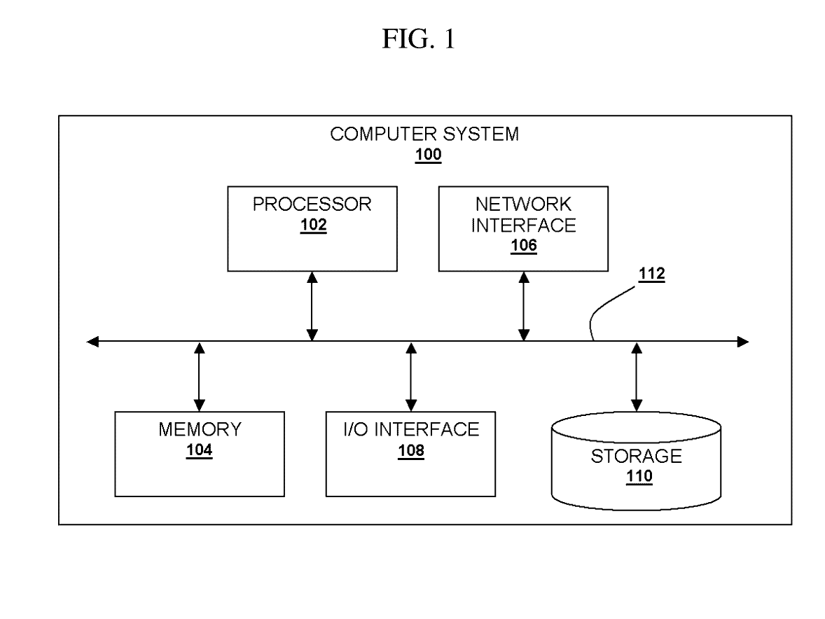

The systems and methods disclosed herein can be implemented using one or more computer systems, such as the exemplary embodiment of a computer system 100 shown in FIG. 1. As shown, the computer system 100 can include one or more processors 102 which can control the operation of the computer system 100. The processor(s) 102 can include any type of microprocessor or central processing unit (CPU), including programmable general-purpose or special-purpose microprocessors and/or any one of a variety of proprietary or commercially available single or multi-processor systems. The computer system 100 can also include one or more memories 104, which can provide temporary storage for code to be executed by the processor(s) 102 or for data acquired from one or more users, storage devices, and/or databases. The memory 104 can include read-only memory (ROM), flash memory, one or more varieties of random access memory (RAM) (e.g., static RAM (SRAM), dynamic RAM (DRAM), or synchronous DRAM (SDRAM)), and/or a combination of memory technologies.

The various elements of the computer system 100 can be coupled to a bus system. The bus system can be any one or more separate physical busses, communication lines/interfaces, and/or multi-drop or point-to-point connections, connected by appropriate bridges, adapters, and/or controllers. The computer system 100 can also include one or more network interface(s) 106, one or more input/output (IO) interface(s) 108, and one or more storage device(s) 110.

The network interface(s) 106 can enable the computer system 100 to communicate with remote devices (e.g., other computer systems) over a network, and can be, for example, remote desktop connection interfaces, Ethernet adapters, and/or other local area network (LAN) adapters. The IO interface(s) 108 can include one or more interface components to connect the computer system 100 with other electronic equipment. For example, the IO interface(s) 108 can include high speed data ports, such as USB ports, 1394 ports, etc. Additionally, the computer system 100 can be accessible to a human user, and thus the IO interface(s) 108 can include displays, speakers, keyboards, pointing devices, and/or various other video, audio, or alphanumeric interfaces. The storage device(s) 110 can include any conventional medium for storing data in a non-volatile and/or non-transient manner. The storage device(s) 110 can thus hold data and/or instructions in a persistent state (i.e., the value is retained despite interruption of power to the computer system 100). The storage device(s) 110 can include one or more hard disk drives, flash drives, USB drives, optical drives, various media cards, and/or any combination thereof and can be directly connected to the computer system 100 or remotely connected thereto, such as over a network. The elements illustrated in FIG. 1 can be some or all of the elements of a single physical machine. In addition, not all of the illustrated elements need to be located on or in the same physical or logical machine. Rather, the illustrated elements can be distributed in nature, e.g., using a server farm or cloud-based technology. Exemplary computer systems include conventional desktop computers, workstations, minicomputers, laptop computers, tablet computers, PDAs, mobile phones, and the like.

Although an exemplary computer system is depicted and described herein, it will be appreciated that this is for sake of generality and convenience. In other embodiments, the computer system may differ in architecture and operation from that shown and described here.

Modules

The various functions performed by the computer system 100 can be logically described as being performed by one or more modules. It will be appreciated that such modules can be implemented in hardware, software, or a combination thereof. It will further be appreciated that, when implemented in software, modules can be part of a single program or one or more separate programs, and can be implemented in a variety of contexts (e.g., as part of an operating system, a device driver, a standalone application, and/or combinations thereof). In addition, software embodying one or more modules is not a signal and can be stored as an executable program on one or more non-transitory computer-readable storage mediums. Functions disclosed herein as being performed by a particular module can also be performed by any other module or combination of modules.

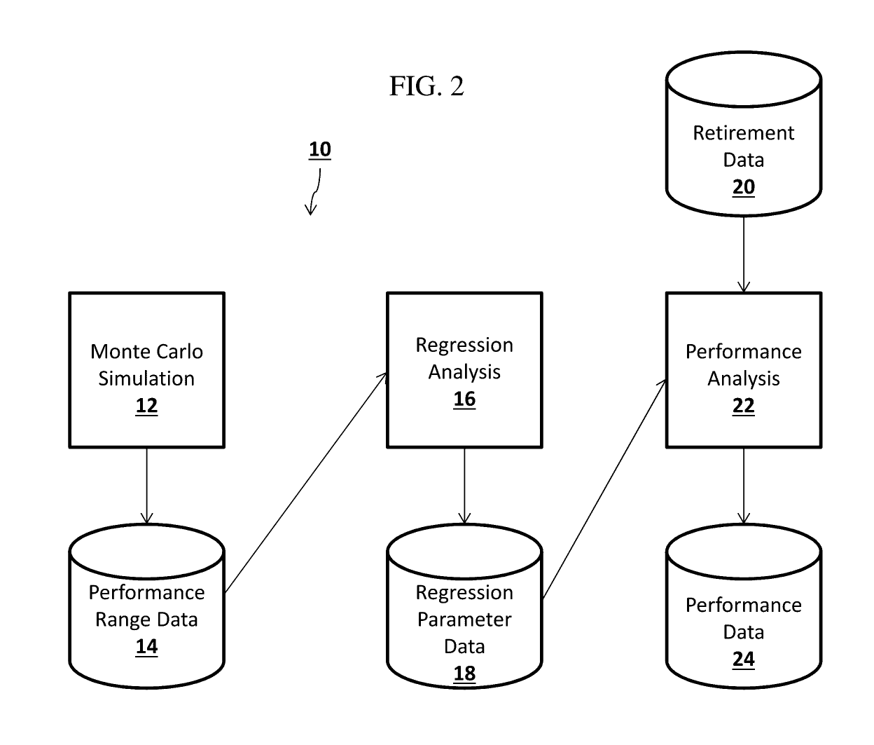

An exemplary system 10 for carrying out the invention is illustrated in FIG. 2 and can operate as follows: given values for a set of input variables related to an exemplary investment portfolio, a Monte Carlo simulation module 12 runs a Monte Carlo simulation to produce a range of estimates for a value of the exemplary portfolio at retirement. The simulation can be run for several values of the sets of input variables, and the corresponding estimate ranges can be stored in a database in association with each of the input variable sets. Based on this data, the regression analysis module 16 can fit regression models for predicting portfolio value at retirement based on any given set of input variables. In an exemplary embodiment, the regression analysis module 16 can produce a first model that relates an upper value limit to the set of input variables, a second model that relates an average value to the set of input variables, and a third model that relates a lower value limit to the set of input variables. A performance analysis module 22 can use the regression models to estimate upper, average, and lower values at retirement for any given set of input variables without running a new Monte Carlo simulation. In some embodiments, the performance analysis module 22 can calculate values for input variables that are asset-specific, based on an identity of the assets within a portfolio to be analyzed. In this way, the invention provides the analytical flexibility of a Monte Carlo simulation, but nearly instantaneously and for an investor's actual portfolio.

The system can include fewer or more modules than what is shown and described herein and can be implemented using one or more digital data processing systems of the type described above. The system can thus be implemented on a single computer system, or can be distributed across a plurality of computer systems, e.g., across a “cloud.” The system also includes a plurality of databases, which can be stored on and accessed by computer systems. It will be appreciated that any of the modules or databases disclosed herein can be subdivided or can be combined with other modules or databases.

Monte Carlo Simulation

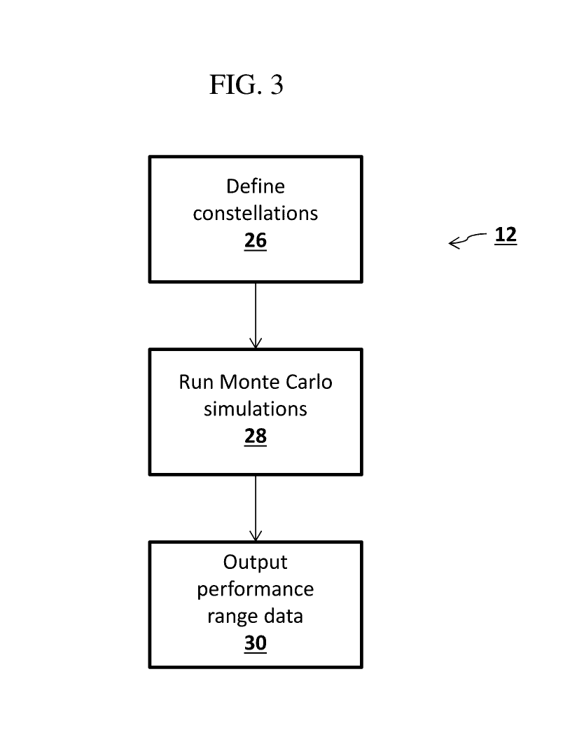

An exemplary method performed by the Monte Carlo simulation module 12 is illustrated in FIG. 3. A first step 26 of the exemplary method is to define values for a set of input variables, or “constellations” for running a Monte Carlo simulation. The set of input variables can generally include financial factors related to an investment portfolio and investor-specific factors related to an investor's retirement plans. In an exemplary embodiment, the investor-specific factors can include time to retirement, monthly contribution, and initial savings. In some embodiments, to reduce the number of input variables, the monthly contribution and the initial savings can be combined into a single factor, the contribution rate, which is equal to the monthly contribution divided by the initial savings and can be capped at 100%. The financial factors can include inflation rate, portfolio expected return, and portfolio volatility.

In some embodiments, the values for the input variables can be manually set by an administrator to include several values within an anticipated range for each variable. By way of non-limiting example, the time to retirement can range from 1 year to 40 years, in increments of one year, and portfolio volatility can range from 0% to 30%, in increments of 1%. The Monte Carlo simulation module 12 then enumerates all possible combinations (or “constellations”) of the input variables for running through a Monte Carlo simulation.

In some embodiments, the portfolio expected return and volatility can be calculated by the Monte Carlo simulation module 12 for actual portfolios of financial assets. First, the Monte Carlo simulation module 12 can calculate a portfolio expected return value R based on the assumption that the economy exists in one of a plurality of states. By way of non-limiting example, the calculation can be based on the assumption that the economy exists in either a strong, normal, or weak state, as shown below. Each state has an associated probability p, which, in an exemplary embodiment, can be the same for every asset. For a portfolio having n assets total, an expected return Rᵢ of the i^{th} asset can be calculated using equation (A).

Rᵢ=pₛ*rᵢₛ+pₙ*rᵢₙ+p_{w}*r_{iw} (A)

pₛ, pₙ, p_{w} denote probabilities in strong, normal and weak regimes, respectively rᵢₛ, rᵢₙ, r_{iw} represent the i^{th} asset's expected return in each economic regime

The asset expected return r under each regime can be calculated in various ways. By way of non-limiting example, for each regime, the Monte Carlo simulation module 12 can select time periods that correspond to that regime (regime periods RP), e.g., based on the performance of a market indicator. For each of the periods RP, the Monte Carlo simulation module 12 can compute the asset's expected return r. In another embodiment, once the Monte Carlo simulation module 12 has set the regime periods RP, the Monte Carlo simulation module 12 can compute average returns (“shifts”) for each of a plurality of economic and financial variables referred to as factors F. There are n factors F, each having a corresponding shift. The Monte Carlo simulation module 12 can then perform regression equations correlating the asset returns with the factor shifts for each regime period RP to produce a set of coefficients. Thus, for example, a return rᵢₛ of the asset I in the strong regime can be computed using equation (B).

rᵢₛ=coef₁*shift₁+coef₂*shift₂+ . . . +coefₙ*shiftₙ (B)

The portfolio expected return R can then be calculated using equation (C), where the weight w of each asset is its dollar value divided by the portfolio dollar value.

R=Σ₁ⁿwᵢRᵢ (C)

The portfolio volatility can be calculated by correlating the expected return R of each asset in the portfolio with each of the plurality of factors. There are a total of m factors. For each asset, the Monte Carlo simulation module 12 can construct a model by selecting a set of factors and assigning weights to the factors. For example, equation (D) is a model for the i^{th} asset.

Rᵢ=βᵢ₀+βᵢ₁*Factor₁+βᵢ₂*Factor₂+ . . . +βᵢₘ*Factorₘ+εᵢ (D)
Rᵢ is the return of the i^{th} asset
βᵢ₀, βᵢ₁, . . . , βᵢₘ are exposures to each of the factors
Factorⱼ is the return of the j^{th} factor
εᵢ is the error term

For n assets, in matrix form, equation (D) can be expressed as equation (E).

R=β₀+βF+ε (E)
R contains all assets in the portfolio
β₀ represents the constant terms in each asset model
β represents the exposure of each asset to its factors
ε denotes the asset error terms

Combining all the assets in the portfolio produces equation (F) for the portfolio returns Portfolio, where w is the weight matrix.

Portfolio=w (β₀+βF+ε) (F)

Then, assuming independence between factor returns and error terms, the portfolio variance can be calculated using equation (G).

Volatility=\sqrt{σ²}=\sqrt{w(β×β′+S)w′} (F)
σ is the portfolio variance
X is the variance-covariance matrix of the factor returns
S is the specific risk of the assets, after the factor risk is removed
β×β′+S is the variance—covariance matrix of the assets.

Given a set of values for all the input variables (“a constellation”), in step 28, the Monte Carlo simulation module 12 can run a Monte Carlo simulation. Each run can produce a plurality of simulated paths, each path having a terminal value S_{T} that corresponds to an amount of money in a portfolio at retirement. In general, the number of simulated paths can be on the order of 10,000. Each path can be simulated by repeatedly drawing a random number that represents a portfolio expected return over a time period t (e.g., a month, a year, etc.) for an entire time period until retirement T. The random number can be drawn from a probability distribution that depends on the portfolio expected return R and portfolio volatility, which can be calculated as described above. Equation (H) can then be applied for each simulated path, thereby producing multiple possible estimates of the amount of money at retirement S_{T} for each constellation.

Sₜ₊₁=(Sₜ+c)(1+zₜ−i) (H)

for t=0,1, . . . , T−1
t time
T time of retirement
zₜ monthly return of portfolio at time t, a random quantity
i monthly inflation rate
c monthly contribution

The Monte Carlo simulation module 12 can define an upper value limit, an average value, and a lower value limit for each constellation based on the terminal values S_{T} of the simulated paths. In an exemplary embodiment, the upper value limit is defined as the 90^{th} percentile of the terminal values S_{T} and the lower value limit is defined as the 10^{th} percentile of the terminal values S_{T}. In some embodiments, the Monte Carlo simulation module 12 can further determine a rate of return that each of the terminal values S_{T} represents on the user's investment.

Table 1 illustrates exemplary inputs and outputs from two runs of the Monte Carlo simulation by the Monte Carlo simulation module 12. As shown in Table 1, for each constellation, the Monte Carlo simulation module 12 can produce an upper limit, an average value, and a lower limit for the rate of return. The limits and average for each constellation, as well as their associated constellation, can be included in performance range data 14 that can be output by the Monte Carlo simulation module 12, e.g., to a database (step 30). It will be appreciated by a person skilled in the art that any value produced by the Monte Carlo simulation can be calculated and/or stored as performance range data 12, e.g., a median value of the value of the portfolio, a mode of the value of the portfolio, etc. Furthermore, any of the intermediate values calculated by the Monte Carlo simulation module 14, e.g., the asset rate of return, the portfolio rate of return, the portfolio volatility, etc., can be stored in the database. These values can be retrieved later by the performance analysis module 22 for further analysis, as explained below.

TABLE 1
Monte Carlo input and output

| | Run1 | Run2 |
|---|---|---|
| INPUTS | | |
| Time to retirement | 1 | 2 |
| Inflation rate | 3% | 3% |
| Contribution rate | 5% | 5% |
| Portfolio expected return | 8% | 8% |
| Portfolio volatility | 12% | 12% |
| OUTPUTS | | |
| Lower Limit | 5% | 4% |
| Average | 7% | 8% |
| Upper Limit | 10% | 11% |

Regression Analysis Module

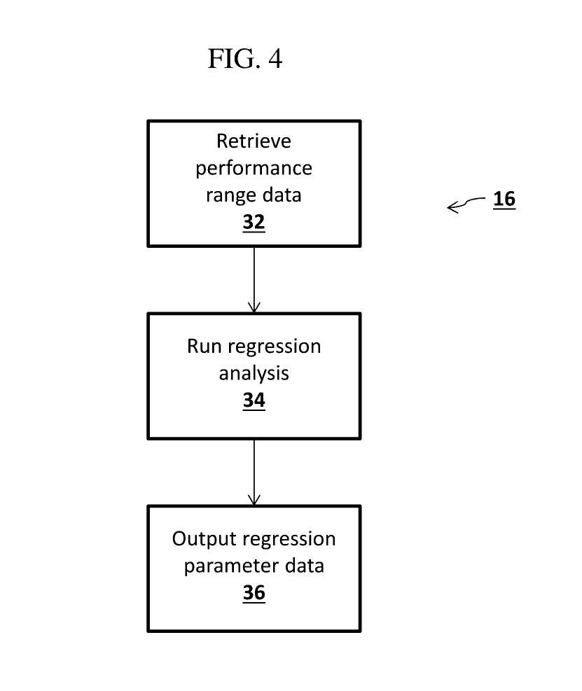

The regression analysis module 16 creates regression equations to estimate portfolio value at retirement without running a Monte Carlo simulation. An exemplary method performed by the regression analysis module 16, illustrated in FIG. 4, begins with retrieving the performance range data 14 (step 32) output from the Monte Carlo simulation module 12. Using the upper limit, the average value, and the lower limit for each constellation, the regression analysis module 16 can fit three regression models—one that correlates the upper limit with each of the input variables in the constellation, one that correlates the average value with each of the input variables in the constellation, and one that correlates the lower limit with each of the input variables in the constellation (step 34). The regression analysis can be performed using several models, although in some embodiments only the result from the best model is output. The best model can include blended models, and can be determined using statistical and non-statistical measures of accuracy. In an exemplary embodiment, the result is three regression equations that can be used to compute an estimated upper limit, average, and lower limit for the value of any portfolio at retirement based on any set of input variables. The equations can be output, e.g., to a database, as regression parameter data 18 (step 36). Although the exemplary embodiment produces three regression equations for modeling an upper limit, average, and lower limit of a given portfolio's value, it will be appreciated by a person skilled in the art that regression equations can be created for correlating the input variables with any value within the performance estimate ranges produced by the Monte Carlo simulation module 12. Furthermore, the regression analysis module 16 can correlate any set of input variables with a portfolio's value at retirement, either the same or different from the input variables that were input to the Monte Carlo simulation module 12.

Performance Analysis Module

Given at least one regression equation relating input variables to portfolio value at retirement, the performance analysis module 22 can estimate the portfolio value at retirement for any given values of the input variables. The at least one regression equation can be simple enough to allow for near instantaneous calculation of the value of any given portfolio. Thus, a user can change any of the input variables and immediately know how it will impact the user's savings at retirement. Because of the limited computational power requirements, the performance analysis module 22 can be run on a variety of mobile devices, thereby allowing users to “play” with different variables at any time.

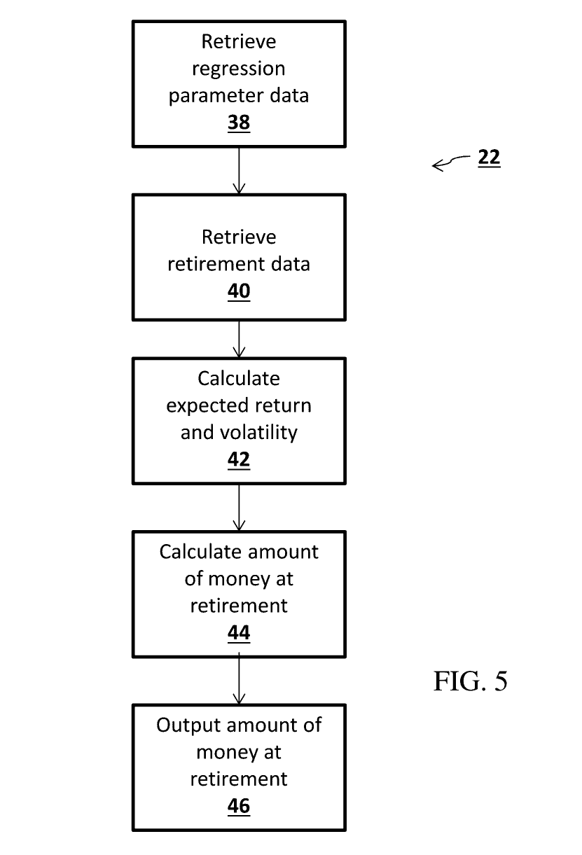

An exemplary method performed by the performance analysis module 22 is illustrated in FIG. 5 and begins with retrieving the regression parameter data (step 38) and retrieving retirement data 20 (step 40). The retirement data 20 can include the same input variables used for the Monte Carlo simulation, i.e., time to retirement, contribution rate, inflation rate, portfolio expected return, and portfolio volatility. However, the input variables need not be the same as those used for the Monte Carlo simulation. In general, the retirement data 20 can be input by a user and/or automatically uploaded to the performance analysis module 22 from a third party source, e.g., a financial institution.

In some embodiments, e.g., where portfolio expected return and portfolio volatility are not known, the portfolio expected return and the portfolio volatility can be calculated by the performance analysis module 22 (step 42) using methods similar to those outlined above as being performed by the Monte Carlo simulation module 12. In such embodiments, the retirement data 20 input to the performance analysis module 24 can simply include identities of the assets within a portfolio and their weight w within the portfolio. Based on this information, the performance analysis module 22 can produce estimates of portfolio expected return and portfolio volatility. In this way, the performance analysis module 22 can instantaneously calculate savings at retirement for the specific assets within an investor's retirement portfolio—not just for broad categories of assets that may or may not serve as an indication of a particular asset's performance.

Where an expected return of an asset within the retrieved portfolio, an expected return of the retrieved portfolio, and/or a volatility of the retrieved portfolio have already been calculated by the Monte Carlo simulation module 12, the performance analysis module 22 can simply retrieve these values from the database where they are stored. This can further expedite the calculation of portfolio value at retirement and lower computational power requirements for the performance analysis module 22.

Given the portfolio volatility and expected rate of return, as well as values for the other input variables included in the retirement data 20, the performance analysis module 22 can calculate an upper limit, an average value, and a lower limit for the amount of money in the retrieved portfolio at retirement using the regression equations produced by the regression analysis module 16 (step 44). In step 46, the resulting upper limit, average value, and lower limit can be output as portfolio performance data 24 to a database and/or to an interactive user interface, explained below.

In other embodiments, the performance analysis module 22 can rely solely on the performance range data 14 output from the Monte Carlo simulation module 12 for determining a value of the retrieved portfolio at retirement. For example, given values for a set of input variables related to the retrieved portfolio, the performance analysis module 22 can simply look up a constellation within the performance range data 14 having values that are equal to the given values. The performance analysis module 22 can simply output the upper limit, average value, and lower limit associated with the constellation in the performance range data 14 as the limit, average value, and lower limit for the retrieved portfolio. Where there is no constellation within the performance range data 14 that precisely matches the given values, the performance analysis module 22 can interpolate the performance range data 14 to determine estimated values of the retrieved portfolio at retirement. In some embodiments, the interpolation can be as simple as rounding values.

In still further embodiments, the performance analysis module 22 can simply calculate an estimated average value of a portfolio at retirement using equation (I).

$${S}_{T} = {S}_{0} {g}^{n} + c \frac{{g}^{n + 1} - g}{g - 1} \qquad ( I )$$

S₀ current savings
S_{T} savings at retirement
r monthly expected return of portfolio
i monthly inflation rate
c monthly contribution
n months to retirement
g growth factor=1+r−i

Using any of the aforementioned methods for calculating a portfolio value at retirement, the performance analysis module 22 can provide a user with a means for comparing alternative portfolios and/or portfolios under different circumstances to help the user match investment options with a desired amount and/or range of savings at retirement. For example, a second portfolio, including a second subset of assets that is different from a first subset of assets that make up the user's current portfolio, can be input to the performance analysis module 22, which can calculate a value for the second portfolio at retirement. The resulting portfolio value at retirement can then be output to the user, optionally alongside the value at retirement of the user's current portfolio. The performance analysis module 22 can repeat the calculation step for multiple portfolios and/or under multiple different circumstances to allow a user to compare different retirement investment strategies.

User Interface

The performance range data 24 calculated by the performance analysis module 22 can be displayed on one or more user interfaces to allow a user to immediately view the impact of changes in any of the aforementioned input variables on his or her savings at retirement. The user interface can be implemented on a variety of electronic devices, for example as a web application, a mobile phone application etc.

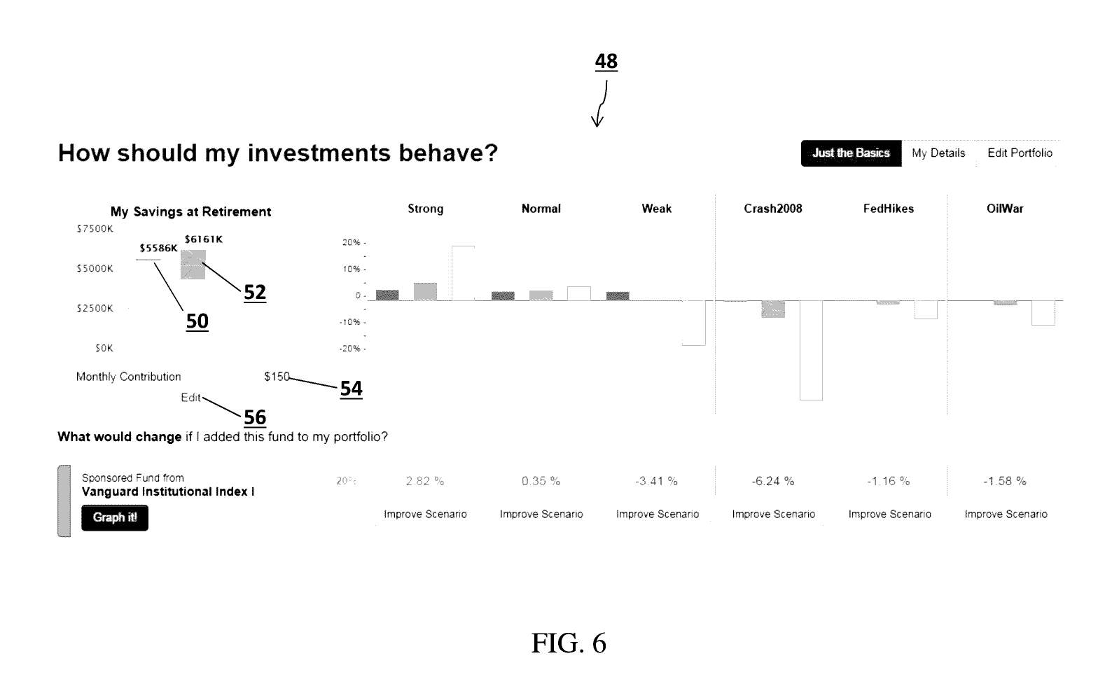

One exemplary embodiment of a user interface 48 is illustrated in FIG. 6. In relevant part, the user interface 48 allows for a user to view range estimates of the amount of savings at retirement for two alternative portfolios. A first portfolio 50 can be the user's current portfolio, and a second portfolio 52 can be an alternative portfolio, e.g., a portfolio including only a benchmark asset. For each portfolio, the user interface 48 can graphically depict a range between upper and lower limits of the value of the portfolio at retirement, as calculated by the performance analysis module 22. In the exemplary embodiment, the range is depicted by a bar, with the number for the upper limit for each portfolio being displayed adjacent to the bar. Viewing each of the portfolios in a side-by-side comparison can enhance user understanding of the user's portfolio relative to other portfolios and of the assets within the user's portfolio. Additionally or alternatively, any of the aforementioned input variables can be displayed on the interface 48, e.g., the monthly contribution 54 can be displayed.

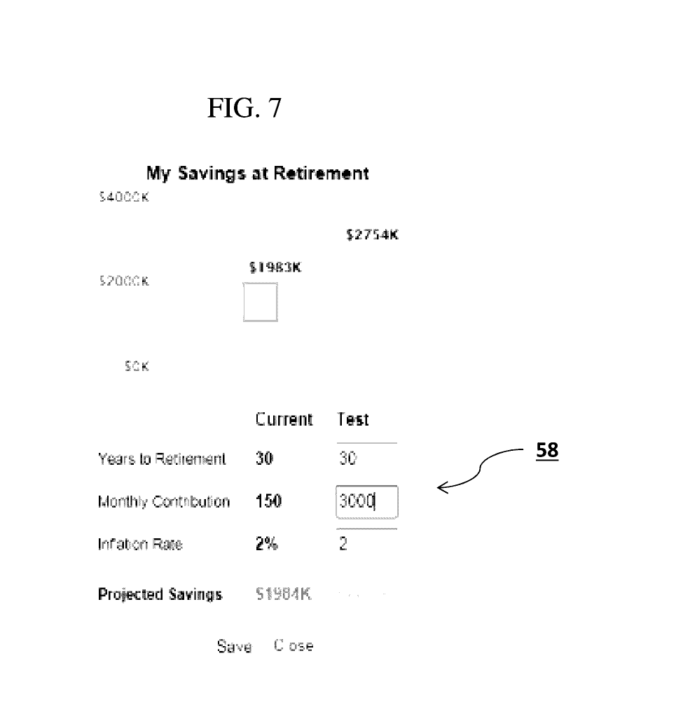

A user interface according to the present invention can be interactive. For example, by clicking on “edit” button 56 of the user interface 48, the user can edit a subset of the input variables for the performance analysis module 22. Clicking on the “edit” button 52 can bring up a window 58 (FIG. 7) that allows the user to edit values of various input variables by entering a value for the input variable in a text box next to the input variable's name. In the illustrated embodiment, the user can set a value for the number of years to retirement, the user's monthly contribution to retirement accounts, and the inflation rate. The edited, or “test” values can be run through the performance analysis module 22 to produce a second value range estimate that is displayed alongside the value range estimate for the user's current portfolio, thereby allowing the user to immediately understand how changes in the input variables may impact savings at retirement.

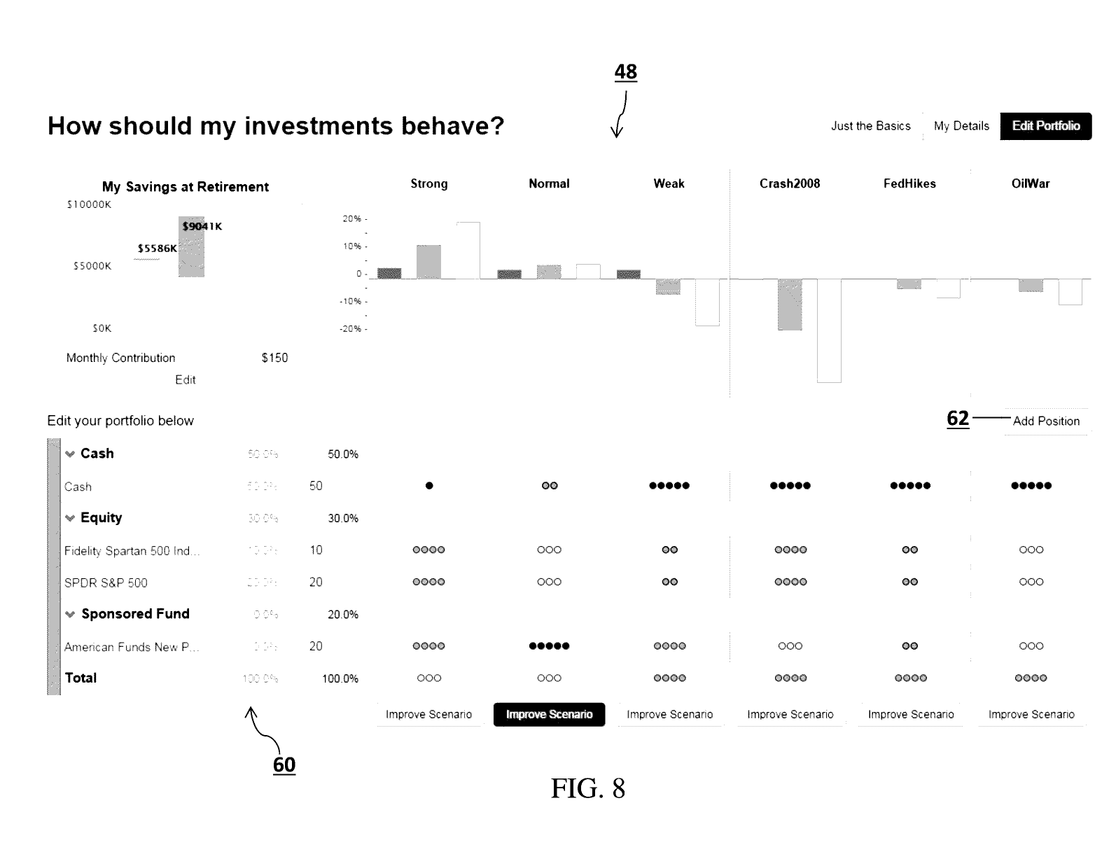

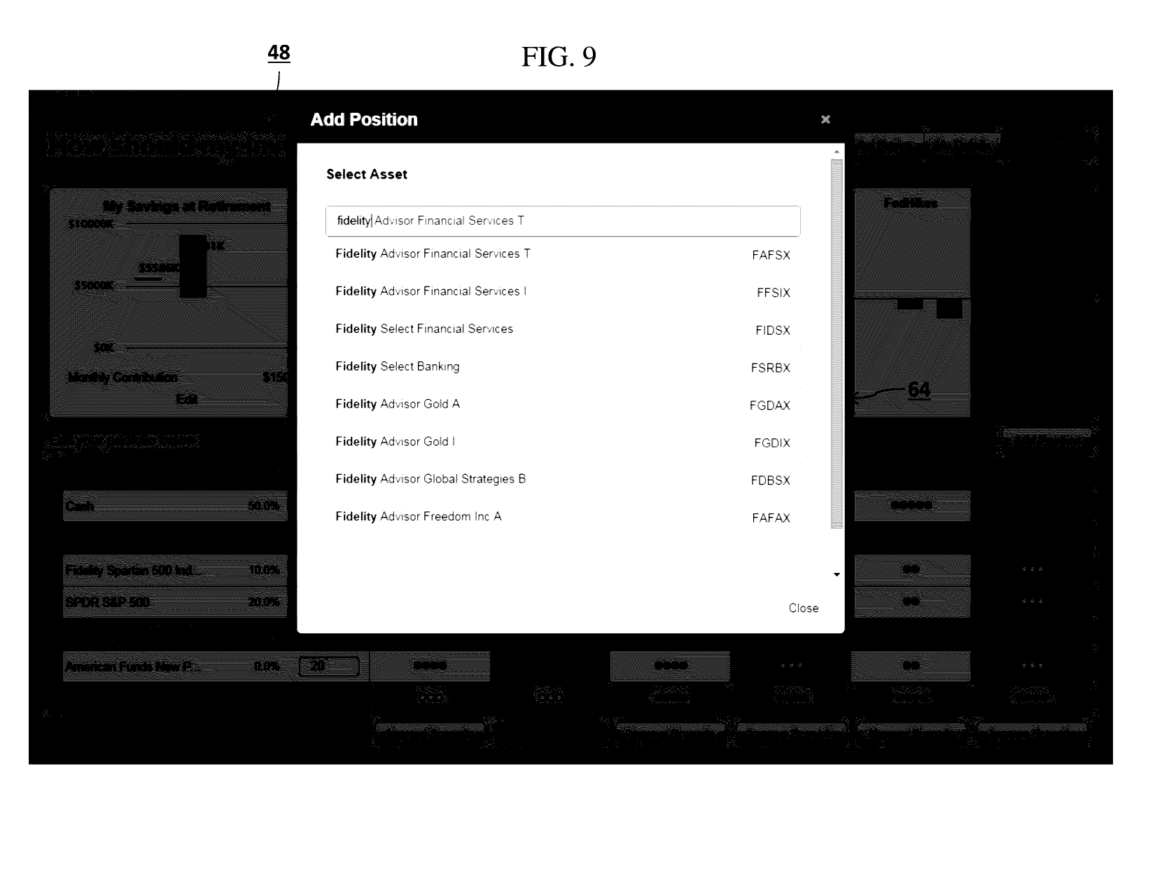

In some embodiments, the composition of the user's portfolio can be altered in the user interface 48. For example, as illustrated in FIG. 8, the user can manually change a weight of each asset within the user's portfolio by manually entering a percentage in a text box adjacent to the asset in the window 60. In still further embodiments, a user can change which assets are included in their portfolio. For example, by clicking on button 62 (“add position”), the user can be presented with a window 64, illustrated in FIG. 9, that provides a list of assets that a user can add to their portfolio. The listed assets can be selected from among a subset of retirement assets in which the user is allowed to invest. The user can select any one or more assets to add to the user's current portfolio to create an alternative portfolio, which can then be input to the performance analysis module 22. The resulting value range estimate of the alternative portfolio can be displayed alongside the value range estimate of the user's current portfolio, thereby demonstrating to the user how the one or more additional funds would impact the user's savings at retirement.

The ability to add additional funds to a user's portfolio and immediately view the impact on savings at retirement can be particularly useful for advertising. In some embodiments, each listed asset in the window 64 can be a sponsored asset. There can be a user actuable link to information regarding the one or more suggested sponsored funds in the list, each of which can be associated with an advertising fee. For example, the number of clicks on the actuable link can be tracked to charge the advertiser a fee for each click. Suggestions for sponsored funds can be provided at the request of the user, e.g., by clicking on the button 62, and/or automatically.

What is claimed is:

1. A method for predicting a value of one or more portfolios of financial assets at retirement using a system comprising one or more computer processors connected to one or more computer databases, the method comprising:
accessing from the one or more databases, by the one or more computer processors, regression parameters that approximate a Monte Carlo simulation and that correlate a set of input variables with an estimated value of a portfolio at retirement;
accessing, by the one or more computer processors, values for the set of input variables that correspond to a user portfolio and a retirement strategy; and
calculating, by the one or more computer processors, an estimated value of the user portfolio at retirement using the regression parameters and without running a Monte Carlo simulation.

2. The method of claim 1, wherein the input variables comprise at least one of an amount of time until retirement, an amount of money contributed to the user portfolio on a regular basis, an inflation rate, a volatility of the user portfolio, and an expected return of the user portfolio.

3. The method of claim 2, wherein where the input variables comprise the expected return of the user portfolio and the volatility of the user portfolio, the one or more computer processors calculate the expected return and the volatility of the user portfolio.

4. The method of claim 1, further comprising:
providing by the one or more computer processors a user interface that allows a user to specify a second set of values for the input variables, where at least one of the values for the input variables in the first set is different from a value of that input variable in the second set.

5. The method of claim 4, further comprising:
accessing the one or more databases by the one or more computer processors to retrieve the regression parameters and calculating a value of the user portfolio at retirement using the regression parameters based on the second set of values; and
outputting by the one or more computer processors to the user interface the values of the user portfolio at retirement based on the first set of values and the second set of values.

6. The method of claim 1, further comprising:
retrieving by the one or more computer processors a second set of values for the input variables that corresponds to a second portfolio;
accessing the one or more databases by the one or more computer processors to retrieve the regression parameters and calculating a second value of the second portfolio at retirement using the regression parameters; and
outputting by the one or more computer processors to a computer display the values of the first portfolio and the second portfolio at retirement.

7. The method of claim 6, wherein the retrieving by the one or more computer processors of a second set of values for the input variables that corresponds to the second portfolio further comprises:
providing by the one or more computer processors a user interface for a user to indicate allocations of a limited subset of financial assets in which the user is allowed to invest for retirement, and creating from indicated allocations the second portfolio.

8. The method of claim 6, wherein the second portfolio includes at least one sponsored financial asset.

9. The method of claim 1, wherein the estimated value comprises at least one of an upper limit, a lower limit, and an average.

10. A method for predicting a value of one or more portfolios of financial assets at retirement using a system comprising one or more computer processors connected to one or more computer databases, the method comprising:
running, by the one or more computer processors, a Monte Carlo simulation to determine a value of each of a plurality of portfolios at retirement;
performing, by the one or more computer processors, a regression analysis for each of the values with respect to a plurality of variables relating to each of the portfolios and storing the regression parameters in the one or more databases; and
accessing the one or more databases by the one or more computer processors to retrieve the regression parameters, retrieving a set of values for the input variables that correspond to a user portfolio, and calculating a value of the user portfolio at retirement using the regression parameters.
